(19) United States
(12) Patent Application Publication
(10) Pub. No.: US 2011/0079962 A1
(43) Pub. Date: Apr. 7, 2011

(54) MODULAR POLYMERIC EMI/RFI SEAL

(75) Inventors: Donald M. Munro, Long Beach, CA (US); Jon M. Lenhert, Brea, CA (US); Karthik Vaideeswaran, Redondo Beach, CA (US); Jose R. Sousa, East Providence, RI (US)

(73) Assignee: SAINT-GOBAIN PERFORMANCE PLASTICS CORPORATION, Aurora, OH (US)

(21) Appl. No.: 12/897,398

(22) Filed: Oct. 4, 2010

Related U.S. Application Data
(60) Provisional application No. 61/248,152, filed on Oct. 2, 2009.

(51) Int. Cl. F16J 15/16; F16J 15/02; B29C 37/00

(52) U.S. Cl. 277/500; 277/650; 264/138

(57) ABSTRACT

A seal includes a seal body including an annular cavity, and an annular spring within the annular cavity. The seal body, the seal body includes a composite material having a thermoplastic material and a filler. The composite material can have a Young's Modulus of at least about 0.5 GPa, a volume resistitivity of not greater than about 200 Ohm-cm, an elongation of at least about 20%, a surface resistitivity of not greater than about 10⁴ Ohm/sq, or any combination thereof.

### CROSS-REFERENCE TO RELATED APPLICATION(S)

The present application claims priority from U.S. Provisional Patent Application No. 61/248,152, filed Oct. 2, 2009, entitled “MODULAR POLYMERIC EMI/RFI SEAL,” naming inventors Donald M. Munro, Jon M. Lenhert, Karthik Vaideeswaran and Jose Sousa, which application is incorporated by reference herein in its entirety.

### FIELD OF THE DISCLOSURE

The present disclosure relates generally to electromagnetic interference/radio frequency interference (EMI/RFI) gaskets. More specifically, the present disclosure relates to a modular polymeric EMI/RFI seal and shield.

### BACKGROUND

Electronic noise (EMI) and radio frequency interference (RFI) are the presence of undesirable electromagnetic energy in an electronic system. EMI can result from unintentional electromagnetic energy generate in and around the electronic system. For example, electrical wiring can generate electronic noise at about 60 Hz. Other sources of unintentional electromagnetic energy can include thermal noise, lightning, and static discharges. Additionally, EMI can result from intentional electromagnetic energy, such as radio signals used for radio and television broadcasts, wireless communication systems such as cellular phones, and wireless computer networks.

Elimination of EMI is important in the design of electronic systems. Placement of components within the system, as well as the use of shielding and filtering, make it possible to control and reduce the EMI that interferes with the function of the electronic system as well as the EMI produced by the electronic system that can interfere with other systems. The effectiveness of shielding and filtering is dependent on the methods by which the shielding materials are bonded together. Electrical discontinuities in the enclosure, such as joints, seems, and gaps, all affect the frequency and the amount of EMI that can breach the shielding.

### SUMMARY

In an aspect, a seal can include a seal body including an annular cavity, and an annular spring within the annular cavity. The seal body can include a composite material having a thermoplastic material and a filler. The composite material can have a Young's Modulus of at least about 0.5 GPa, a volume resistitivity of not greater than about 200 Ohm-cm, an elongation of at least about 20%, a surface resistitivity of not greater than about 10⁴ Ohm/sq, or any combination thereof.

In another aspect, a system can include a static component and a rotary component. The rotary component can rotate relative to the static component. Additionally, at least a portion of the static component can be within a portion of the rotary component or at least a portion of the rotary component can be within a portion of the static component. The system can further include a seal between the static component and the rotary component. The seal can include a spring and a casing surrounding the spring. The casing can include a composite material having a thermoplastic and a filler. The composite material can have a Young's Modulus of at least about 0.5 GPa, a volume resistitivity of not greater than about 200 Ohm-cm, an elongation of at least about 20%, a surface resistitivity of not greater than about 10⁴ Ohm/sq, or any combination thereof.

In yet another aspect, a method of making a seal can include forming a casing from a composite material. The composite material can include a thermoplastic material and a filler. The composite material can have a Young's Modulus of at least about 0.5 GPa, a volume resistitivity of not greater than about 200 Ohm-cm, an elongation of at least about 20%, a surface resistitivity of not greater than about 10⁴ Ohm/sq, or any combination thereof. The method can further including machining the casing to form a groove therein, and inserting a spring within the groove.

### BRIEF DESCRIPTION OF THE DRAWINGS

The present disclosure may be better understood, and its numerous features and advantages made apparent to those skilled in the art by referencing the accompanying drawings.

FIG. 1 is an illustration of an exemplary seal according to an aspect.

FIG. 2 is a cross section of the exemplary seal illustrated in FIG. 1.

FIGS. 3 through 6 are illustrations of exemplary springs.

FIG. 7 is an illustration of an exemplary system according to an aspect.

The use of the same reference symbols in different drawings indicates similar or identical items.

### DETAILED DESCRIPTION

In a particular embodiment, a seal can include a seal body can having an annular cavity and an annular spring within the annular cavity. The seal body can include a composite material having a thermoplastic material and a filler.

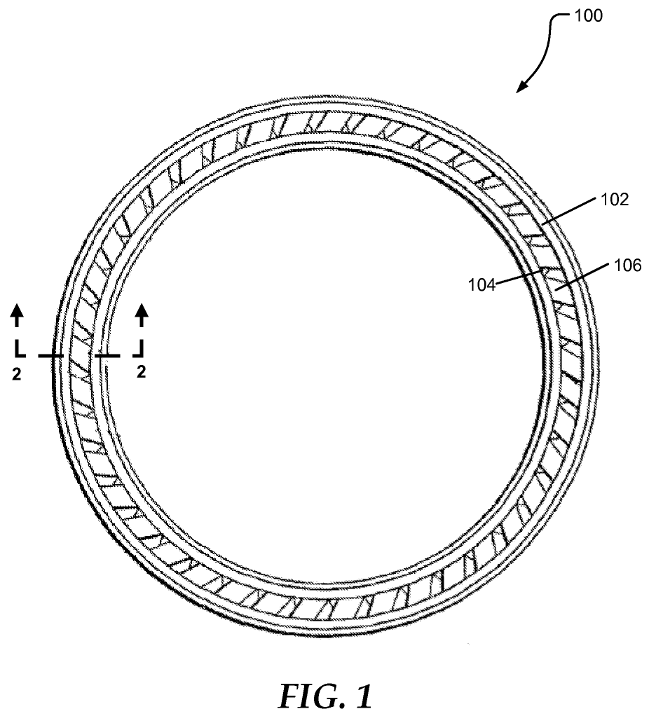

FIG. 1 illustrates an exemplary seal, generally designated 100. Seal 100 includes a seal body 102 having an annular cavity 104. The annular cavity 104 can be formed within the seal body 102 during forming the seal body or by machining. An annular spring 106 can be located within the annular cavity 104.

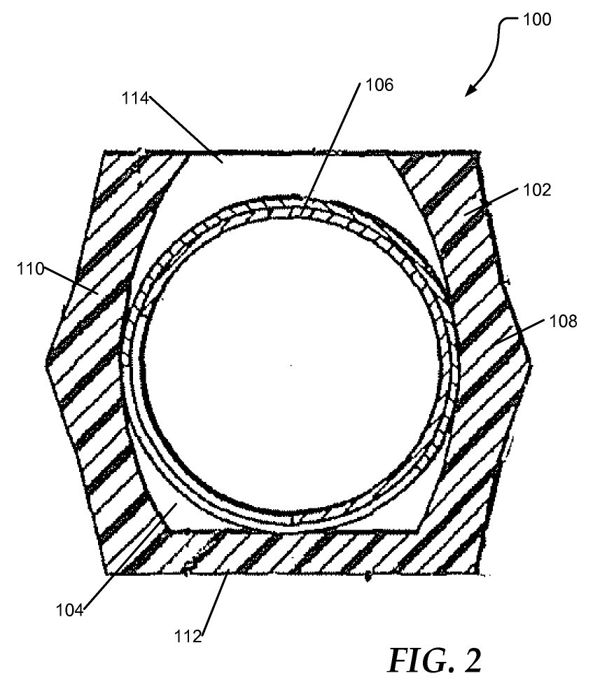

FIG. 2 illustrates a cross section of seal 100 taken along line 2-2 of FIG. 1. As shown in FIG. 2, seal body 102 can include side walls 108 and 110 and a bottom wall 112 attached to each of side walls 108 and 110. Side walls 108 and 110 and bottom wall 112 define annular cavity 104 having an opening 114 opposite bottom wall 112. Spring 106 can be located within the annular cavity 104. Generally, spring 106 can be in contact with each of side walls 108 and 110 and bottom wall 112.

In an embodiment, the seal body can include a composite material. The composite material can include a thermoplastic material, such as an engineering or high performance thermoplastic polymer. For example, the thermoplastic material may include a polymer, such as a polyketone, polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, a liquid crystal polymer, or any combination thereof. In an example, the thermoplastic material includes a polyketone, a polyaramid, a polyimide, a polyetherimide, a polyamideimide, a polyphenylene sulfide, a polyphenylene sulfone, a fluoropolymer, a polybenzimidazole, a derivation thereof, or a combination thereof. In a particular example, the thermoplastic material includes a polymer, such as a polyketone, a thermoplastic polyimide, a polyetherimide, a polyphenylene sulfide, a polyether sulfone, a polysulfone, a polyamideimide, a derivative thereof, or a combination thereof. In a further example, the thermoplastic material includes polyketone, such as polyether ether ketone (PEEK), polyether ketone, polyether ketone, polyether ketone ether ketone, a derivative thereof, or a combination thereof. An example thermoplastic fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof. An exemplary liquid crystal polymer includes aromatic polyester polymers, such as those available under tradenames XYDAR® (Amoco), VECTRA® (Hoechst Celanese), SUMIKOSUPERT™ or EKONOL™ (Sumitomo Chemical), DuPont HX™ or DuPont ZENITE™ (E.I. DuPont de Nemours), RODRUN™ (Unitika), GRANLAR™ (Grandmont), or any combination thereof. In an additional example, the thermoplastic polymer may be ultra high molecular weight polyethylene.

In an embodiment, the composite material can further conductive fillers to improve conductivity, such as metals and metal alloys, conductive carbonaceous materials, ceramics such as borides and carbides, or any combination thereof. In an example, metals and metal alloys can include bronze, aluminum, gold, nickel, silver, alloys thereof, or any combination thereof. Examples of conductive carbonaceous materials include carbon fibers, sized carbon fibers, PAN carbon fibers, carbon nanotubes, carbon nanofibers, carbon black, graphite, extruded graphite, and the like. Additionally, the conductive carbonaceous materials can include carbon fibers and polymer fibers coated with vapor deposited metals, such as silver, nickel, and the like. Examples of ceramics can include borides and carbides. Additionally, the ceramics can be coated or doped ceramics. In a particular embodiment, the conductive filler can be finely dispersed within the composite material. Conductive fillers can be employed to increase the conductivity of the composite material. As such, the conductive filler can have an electrical resistivity of not greater than about 0.1 ohm-cm, such as not greater than about 0.01 ohm-cm, even not greater than about 0.001 ohm-cm.

In an exemplary embodiment, the composite material includes at least about 40.0 wt % conductive filler. For example, the composite material may include at least about 50.0 wt % conductive filler, such as at least about 60.0 wt % conductive filler, at least about 65.0 wt %, at least about 70.0 wt %, or even at least about 75.0 wt % of the conductive filler. However, too much resistivity modifier may adversely influence physical or mechanical properties. As such, the composite material may include not greater than about 95.0 wt % conductive filler, such as not greater than about 90.0 wt % or not greater than about 85.0 wt % conductive filler. In another example, the composite material may include not greater than about 75.0 wt % of the conductive filler. In a particular example, the composite material includes the conductive filler in a range of about 40.0 wt % to about 75.0 wt %, such as a range of about 50.0 wt % to about 75.0 wt %, or even about 60.0 wt % to about 75.0 wt %.

The conductive fillers can increase the ability of current to pass through the composite material and can increase the conductivity the seal. In a particular embodiment, the composite material can have a volume resistivity of not greater than about 200 Ohm-cm, such as not greater than about 100 Ohm-cm, even not greater than about 10 Ohm-cm. Further, the composite material can have a surface resistivity of not greater than about 10⁴ Ohm/sq, such as not greater than about 10³ Ohm/sq, such as not greater than about 10² Ohm/sq, even not greater than about 10 Ohm/sq.

In an embodiment, the composite material can be an elastic material. A Young's modulus can be a measure of the stiffness of the composite material and can be determined from the slope of a stress-strain curve during a tensile test on a sample of the material. The composite material can have a Young's modulus of at least about 0.5 GPa, such as at least about 1.0 GPa, such as at least about 3.0 GPa, even at least about 5.0 GPa.

In an embodiment, the composite material can have a relatively low coefficient of friction. For example, the coefficient of friction of the composite material can be not greater than about 0.4, such as not greater than about 0.2, even not greater than about 0.15.

In another embodiment, the composite material can have a relatively high elongation. For example, the composite material can have an elongation of at least about 20%, such as at least about 40%, even at least about 50%.

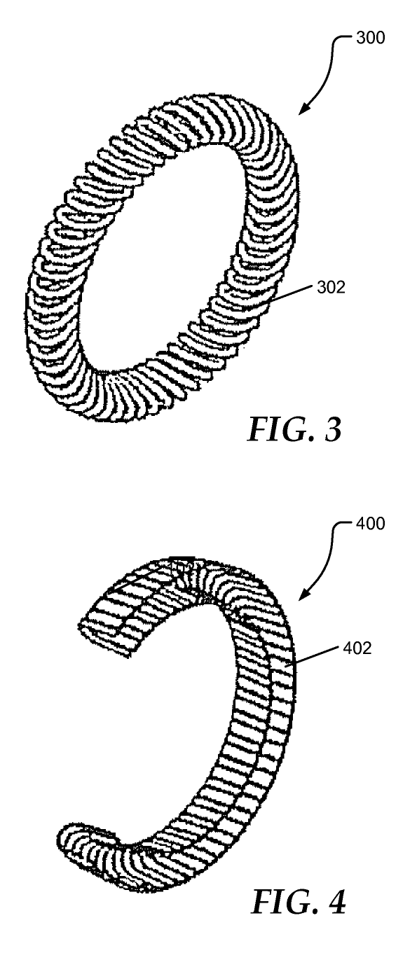

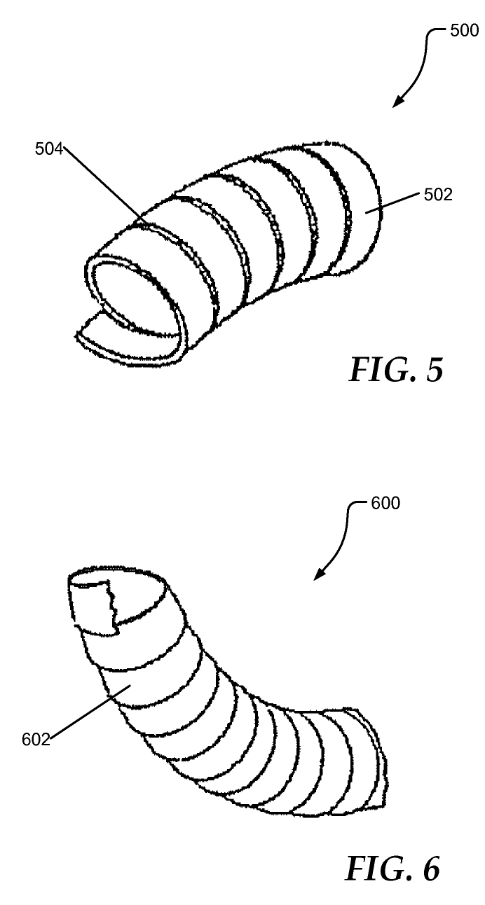

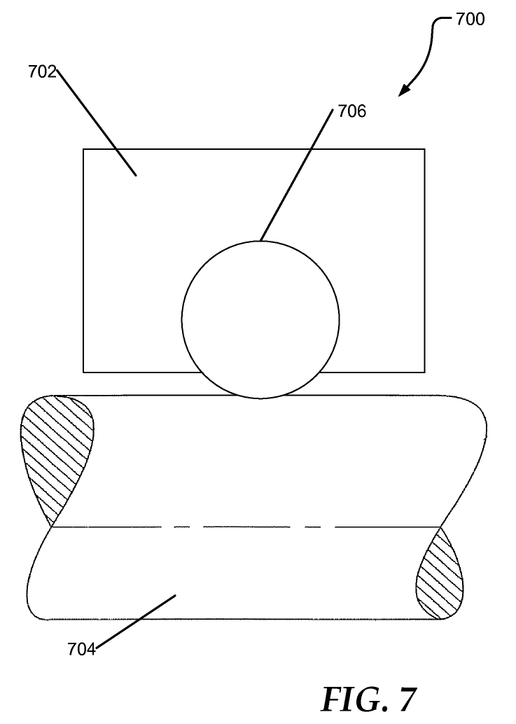

In an embodiment, the spring can be any one of various spring designs. For example, the spring can be a canted coil spring, a U-shaped spring, a helical spring, an overlapped helical spring, or the like. Additionally, the ends of the spring can be joined together, such as be welding, to form an annular spring. FIG. 3 illustrates a canted coil spring 300. The canted coil spring includes a wire 302 that is coiled to form canted coil spring 300. FIG. 4 illustrates a U-shaped spring 400. U-shaped spring 400 includes a metal ribbon 402 formed into U-shaped spring 400. FIGS. 5 and 6 illustrate a helical spring 500 and an overlapped helical spring 600 respectively. In both the helical spring 500 and the overlapped helical spring 600, ribbons 502 and 602 can be formed into a helical shape. The ribbon can have a flat rectangular or near rectangular cross section. While ribbon 502 may be formed into a helical shape with a gap 504 between adjacent windings of the helical spring 500, ribbon 602 can be formed into a helical shape with each winding overlapping the previous winding of the overlapped helical spring 600. The overlap between adjacent windings of the overlapped helical spring can be between about 20% and about 40% of the width of the ribbon.

In an embodiment, the spring can include a conductive material, such as a metal or a metal alloy. The metal alloy can be a stainless steel, a copper alloy such as beryllium copper and copper-chromium-zinc alloy, a nickel alloy such as Hastelloy, Ni220, and Phynox, or the like. Additionally, the spring can be plated with a plating metal, such as gold, tin, nickel, silver or any combination thereof. In an alternative embodiment, the spring can be formed of a polymer coated with a plating metal.

In another embodiment, the seal can be used as a gasket or seal in an electronic system to reduce EMI/RFI and provide a chemical resistant environmental seal. In a particular embodiment, the seal can be placed between two parts of an electronics enclosure, such as between a body and a lid. In another particular embodiment, a seal having a low coefficient of friction can be used between a static component and a rotary component. Preferably, the ends of the spring can be welded together to prevent the formation of a gap in the EMI/RFI shielding. Alternatively, the ends of the spring may not be welded, but can be placed close together to minimize the formation of a gap.

FIG. 7 illustrates an exemplary system 700. System 700 can include a static component 702 and a rotating component 704. The rotating component 704 can rotate relative to the static component 702. The system 700 can further include a seal 706 placed between the static component 702 and the rotating component 704. The seal 706 can be similar to seal 100. In an embodiment, the seal 706 can act to prevent environmental contamination, such as by dust, water, chemicals, gases, or the like, from entering into or exiting the system through the gap between the static component 702 and the rotating component 704. Additionally, the seal 706 can act to reduce EMI/RFI from affecting the system or emanating from the system.

The seal can significantly reduce the electromagnetic energy able to pass through the space between the two parts of the enclosure. For example, the seal may attenuate the electromagnetic energy passing through the space by at least −70 dB, such as at least −80 dB. Additionally, the seal can have a substantially constant attenuation over a range of frequencies, such as between about 1 MHz and about 600 MHz.

Turning to the method of making the seal, the thermoplastic material and filler can be compounded or extruded, such as in a twin-screw extruder, to form the composite material. Compounding can include double compounding and shear mixing. Alternatively, the thermoplastic material and the filler can be blended, such as in a Brabender mixer, or can be milled, such as by dry milling or wet milling to form the composite material. The composite material can be shaped. For example, the composite material can be extruded. Alternatively, the composite material can be pressed into a mold and sintered. Additionally, the composite material may be machined after shaping to form the seal body. The spring can be inserted into the groove of the seal body. In an embodiment, the ends of the spring can be welded prior together prior to inserting into the groove.

### Examples

Samples are tested according to Mil DTL 83528-C to determine volume resistivity. The results are provided in Table 1.

Sample 1 is prepared by blending a PTFE with a 4 wt % carbon filler. A billet is formed by hot pressing.

Sample 2 is prepared as Sample 1 except 12 wt % carbon filler is added.

Sample 3 is prepared as Sample 2 except 20 wt % carbon filler is added.

Sample 4 is prepared by blending PTFE with 40 wt % nickel powder. A billet is formed by cold pressing, followed by sintering.

Sample 5 is prepared as Sample 4 except 50 wt % nickel powder is added.

Sample 6 is prepared as Sample 4 except 55 wt % nickel powder is added.

Sample 7 is prepared by blending PTFE with graphite powder. A billet is formed by cold pressing, followed by sintering.

Sample 8 is an ETFE with a carbon filler.

TABLE 1

| | Volume Resistivity | Elongation | Coefficient of |
|---|---|---|---|
| | (Ohm-cm) | (%) | Friction |
| Sample 1 | 27.6 | 297 | |
| Sample 2 | 2.61 | 167 | |
| Sample 3 | 0.76 | 153 | |
| Sample 4 | 0.55 | 220 | |
| Sample 5 | 0.010 | 165 | 0.28 |
| Sample 6 | 0.0047 | 130 | 0.26 |
| Sample 7 | 19.1 | 170 | |
| Sample 8 | 0.31 | 14 | |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A seal comprising:
a seal body including an annular cavity, the seal body, the seal body including a composite material having a thermoplastic material and a filler, the composite material has a Young's Modulus of at least about 0.5 GPa and a volume resistitivity of not greater than about 200 Ohm-cm; and
an annular spring within the annular cavity.

2. The seal of claim 1, wherein the composite material has a coefficient of friction of not greater than about 0.4.

3. The seal of claim 2, wherein the coefficient of friction is not greater than about 0.2.

4. The seal of claim 3, wherein the coefficient of friction is not greater than about 0.15.

5. The seal of claim 1, wherein the composite material has an elongation of friction of at least about 20%.

6. The seal of claim 5, wherein the elongation is at least about 40%.

7. The seal of claim 6, wherein the elongation is at least about 50%.

8. The seal of claim 1, wherein the Young's Modulus is at least about 1 GPa.

9. The seal of claim 8, wherein the Young's Modulus is at least about 3 GPa.

10. The seal of claim 9, wherein the Young's Modulus is at least about 5 GPa.

11. The seal of claim 1, wherein the volume resistitivity is not greater than about 100 Ohm-cm.

12. The seal of claim 11, wherein the volume resistitivity is not greater than about 10 Ohm-cm.

13. The seal of claim 1, wherein the composite material has a surface resistitivity of not greater than about 10⁴ Ohm/sq.

14. The seal of claim 13, wherein the surface resistitivity is not greater than about 10³ Ohm/sq.

15. The seal of claim 14, wherein the surface resistitivity is not greater than about 10² Ohm/sq.

16. The seal of claim 15, wherein the surface resistitivity is not greater than about 10 Ohm/sq.

17. The seal of claim 1, wherein the thermoplastic material includes a polyketone, a polyaramid, a thermoplastic polyimide, a polyetherimide, a polyphenylene sulfide, a polyethersulfone, a polysulfone, a polyphenylene sulfone, a polyamideimide, ultra high molecular weight polyethylene, a thermoplastic fluoropolymer, a polyamide, a polybenzimidazole, or any combination thereof.

18. The seal of claim 17, wherein the thermoplastic fluoropolymer includes fluorinated ethylene propylene (FEP), polytetrafluoroethylene (PTFE), polyvinylidene fluoride (PVDF), perfluoroalkoxy (PFA), a terpolymer of tetrafluoroethylene, hexafluoropropylene, and vinylidene fluoride (THV), polychlorotrifluoroethylene (PCTFE), ethylene tetrafluoroethylene copolymer (ETFE), ethylene chlorotrifluoroethylene copolymer (ECTFE), or any combination thereof.

19. The seal of claim 1, wherein the filler includes a conductive filler.

20. The seal of claim 19, wherein the conductive filler includes carbon fillers, carbon fibers, carbon particles, graphite, metallic fillers such as bronze, aluminum, and other metals and their alloys, metal oxide fillers, metal coated carbon fillers, metal coated polymer fillers, or any combination thereof.

21. The seal of claim 1, wherein the filler is finely dispersed within the composite material.

22. The seal of claim 1, wherein the annular spring includes a canted coil spring, a U-shaped spring, a helical spring, or an overlapping helical spring.

23. The seal of claim 1, wherein the annular spring is in the form of a helix with a plurality of windings.

24. The seal of claim 1, wherein the annular spring is a closed loop having an annular shape.

25. The seal of claim 1, wherein the annular spring includes a conductive ribbon.

26. The seal of claim 25, wherein the conductive ribbon includes first and second ends welded together.

27. The seal of claim 25, wherein conductive ribbon has a width of between about 0.060 inches and about 0.300 inches.

28. The seal of claim 27, wherein the annular spring has a coil diameter less than about three times the width of the conductive ribbon.

29. The seal of claim 28, wherein the coil diameter is between about 0.060 inches and about 0.250 inches.

30. The seal of claim 25, wherein conductive ribbon has a thickness of between about 0.003 inches and about 0.006 inches.

31. The seal of claim 25, wherein conductive ribbon is formed into an overlapping helical coil.

32. The seal of claim 31, wherein the overlapping helical coil has an overlap distance of between about 20% and about 40% of the width.

33. The seal of claim 1, wherein the annular spring is formed of a metal or metal alloy.

34. The seal of claim 33, wherein the metal alloy includes a nickel alloy, a copper alloy, stainless steel, or any combination thereof.

35. The seal of claim 34, wherein the nickel alloy includes Hastelloy, Ni220, Phynox, or any combination thereof.

36. The seal of claim 35, wherein the a copper alloy includes beryllium copper, copper-chromium-zinc alloy, or any combination thereof.

37. The seal of claim 1, wherein the annular spring is plated with a plating metal.

38. The seal of claim 37, wherein the plating metal includes gold, tin, nickel, silver, or any combination thereof.

39. A seal comprising:
a conductive spring; and
a casing surrounding the spring, the casing including a composite material having a thermoplastic and a filler, the composite material has a elongation of at least about 20% and a volume resistitivity of not greater than about 200 Ohm-cm.

40. The seal of claim 39, wherein the composite material has a Young's Modulus of friction of at least about 0.5 GPa.

41. The seal of claim 39, wherein the composite material has a coefficient of friction of not greater than about 0.4.

42. The seal of claim 39, wherein the composite material has a surface resistitivity of not greater than about 10⁴ Ohm/sq.

43. A seal comprising:
a conductive spring; and
a casing surrounding the spring, the casing including a composite material having a thermoplastic and a filler, composite material has a Young's Modulus of at least about 0.5 GPa and a surface resistitivity of not greater than about 10⁴ Ohm/sq.

44. The seal of claim 43, wherein the composite material has a volume resistitivity of not greater than about 200 Ohm-cm.

45. The seal of claim 43, wherein the composite material has a coefficient of friction of not greater than about 0.4.

46. The seal of claim 43, wherein the composite material has a volume resistitivity of not greater than about 200 Ohm-cm.

47. A seal comprising:
a conductive spring; and
a casing surrounding the spring, the casing including a composite material having a thermoplastic and a filler, the composite material has a elongation of at least about 20% and a volume resistitivity of not greater than about 200 Ohm-cm.

48. The seal of claim 47, wherein the composite material has a coefficient of friction of not greater than about 0.4.

49. The seal of claim 47, wherein the composite material has a surface resistitivity of not greater than about 10⁴ Ohm/sq.

50. The seal of claim 47, wherein the composite material has a Young's Modulus of at least about 0.5 GPa.

51. A system comprising:
a static component;
a rotary component, the rotary component rotates relative to the static component, (i) at least a portion of the static component is within a portion of the rotary component or (ii) at least a portion of the rotary component is within a portion of the static component;
and a seal between the static component and the rotary component; the seal comprising:
a spring; and
a casing surrounding the spring, the casing including a composite material having a thermoplastic and a filler, the composite material has a elongation of at least about 20% and a surface resistitivity of 10⁴ Ohm/sq.

52. The system of claim 51, wherein the composite material has a Young's Modulus of friction of at least about 0.5 GPa.

53. The system of claim 51, wherein the composite material has a coefficient of friction of not greater than about 0.4.

54. The system of claim 51, wherein the composite material has a volume resistitivity of not greater than about 200 Ohm-cm.

55. A method of making a seal, comprising:
forming a casing from a composite material; the composite material including a thermoplastic material and a filler, the composite material has a elongation of at least about 20% and a surface resistitivity of not greater than about 10⁴ Ohm/sq;
machining the casing to form an groove therein; and
inserting a spring within the groove.

56. The method of claim 55, wherein forming includes compression molding and sintering.

57. The method of claim 55, wherein forming includes extruding.

58. The method of claim 55, wherein the composite material has a Young's Modulus of friction of at least about 0.5 GPa.

59. The method of claim 55, wherein the composite material has a coefficient of friction of not greater than about 0.4.

60. The method of claim 55, wherein the composite material has a volume resistitivity of not greater than about 200 Ohm-cm.
